(19) United States
(12) Patent Application Publication
(10) Pub. No.: US 2025/0363352 A1
(43) Pub. Date: Nov. 27, 2025

(54) UNIFIED TRANSFORMER NETWORK FOR LEARNING REPRESENTATIONS FROM MULTIPLE MODALITIES USING MULTIMODALITY PRETRAINING AND MULTIPLE TASKS

(71) Applicant: Typeface Inc., Palo Alto, CA (US)

(72) Inventors: Siddharth Srivastava, New Delhi (IN); Gaurav Sharma, Newark, CA (US)

(21) Appl. No.: 19/202,913

(22) Filed: May 8, 2025

Related U.S. Application Data
(60) Provisional application No. 63/650,834, filed on May 22, 2024.

(51) Int. Cl. G06N 3/08; G06N 3/0455

(52) U.S. Cl. CPC G06N 3/08; G06N 3/0455

(57) ABSTRACT

Methods, systems, and computer programs are presented for implementing a unified transformer network (UTF) for learning representations from multiple modalities through multimodality pretraining and execution of multiple tasks. The method includes identifying various modalities and associated tasks, gathering and annotating training data, configuring the network architecture, and pretraining the network on paired modalities. The UTF is further refined through supervised fine-tuning in a multimodal, multi-task setting. Once trained, the UTF is deployed on a computing device to receive inputs from specified modalities and produce task-specific outputs. The network architecture is designed to handle different modalities with an encoder-decoder structure that includes modality-specific organizers and shared components for cross-modality interactions. This technology enhances the capability of machine learning systems to process and learn from diverse data types, enabling more accurate and efficient performance across a range of applications.

### CROSS-REFERENCE TO RELATED APPLICATIONS

This application claims the benefit of U.S. Provisional Patent No. 63/650,834, filed May 22, 2024, and entitled “Unified Transformer Network for Learning Representations from Multiple Modalities Using Multimodality Pretraining and Multiple Tasks.” This provisional application is herein incorporated by reference in its entirety.

### TECHNICAL FIELD

The subject matter disclosed herein generally relates to methods, systems, and machine-readable storage media for creating models to perform tasks for multiple modalities of items.

### BACKGROUND

Most research in learning-based methods has focused on designing and training networks for specific tasks. Many applied machine learning methods aim to extract valuable representations from data. However, most such methods are modality and task-specific.

One problem is that this approach may limit the ability of machine learning models to learn from and generalize to different types of data. If the model is only trained on a specific task or modality, it may not be able to effectively process or make predictions on new types of data that it has not been trained on.

Another problem is that this approach may require significant resources and time to develop and train separate models for each task and modality. This can be particularly challenging in cases where multiple modalities or tasks need to be integrated into a single system.

Furthermore, this approach may not facilitate cross-modal knowledge sharing, which can limit the ability of machine learning models to learn from and integrate information across different types of data.

### BRIEF DESCRIPTION OF THE DRAWINGS

Various appended drawings illustrate examples of the present disclosure and cannot be considered limiting its scope.

FIG. 1 illustrates the process of creating a unified transformer network for learning representations from multiple modalities using multimodality pretraining and multiple tasks, according to some examples.

FIG. 2 is a flowchart of a method for implementing a unified transformer network for learning representations from multiple modalities using multimodality pretraining and multiple tasks, according to some examples.

FIG. 3 shows a pretraining network with an encoder-decoder network, according to some examples.

FIG. 4 is a flowchart of a method for pretraining the encoder-decoder network, according to some examples.

FIG. 5 illustrates the process of fine-tuning the pre-trained model on multiple modalities and multiple tasks, according to some examples.

FIG. 6 is a flowchart of a method for fine-tuning the pre-trained model on multiple modalities and multiple tasks, according to some examples.

FIG. 7 illustrates the training and use of a machine-learning model, according to some examples.

FIG. 8 is a flowchart of a method for implementing a unified transformer network (UTF) for learning representations from multiple modalities.

FIG. 9 is a block diagram illustrating an example of a machine upon by which one or more examples described herein may be implemented or controlled.

### DETAILED DESCRIPTION

Example methods, systems, and computer programs are directed at implementing a unified transformer network for learning representations from multiple modalities using multimodality pretraining and multiple tasks. Examples merely typify possible variations. Unless explicitly stated otherwise, components and functions are optional and may be combined or subdivided, and operations may vary in sequence or be combined or subdivided. The following description provides numerous specific details to provide a thorough understanding of examples. However, it will be evident to one skilled in the art that the present subject matter may be practiced without these specific details.

Techniques are presented for developing Artificial Intelligence (AI) models to make predictions for various tasks associated with different modalities. A modality refers to a type of data associated with an object represented by the data, where the object for each modality may be an image, video, text, audio, depth maps, three-dimensional (3D) point clouds, etc.

The solution includes a unified multimodal multitask network capable of processing text, images, point clouds, audio, and video for a wide range of tasks. The architecture leverages dedicated tokenizers and dual transformer streams to preserve modality-specific features, while a shared transformer backbone integrates these representations through cross-attention. A dual-stage masked pretraining strategy first aligns ordered modality pairs to capture structured intermodal relationships, then randomizes pairings to boost robustness and generalization. Task-specific and joint task heads facilitate both unimodal classification, segmentation, and retrieval, as well as multimodal tasks such as video/audio question answering and audio-video captioning.

Evaluations demonstrated state-of-the-art results across single-and cross-modal benchmarks, highlighting the method's scalability and effectiveness in multimodal multitask learning.

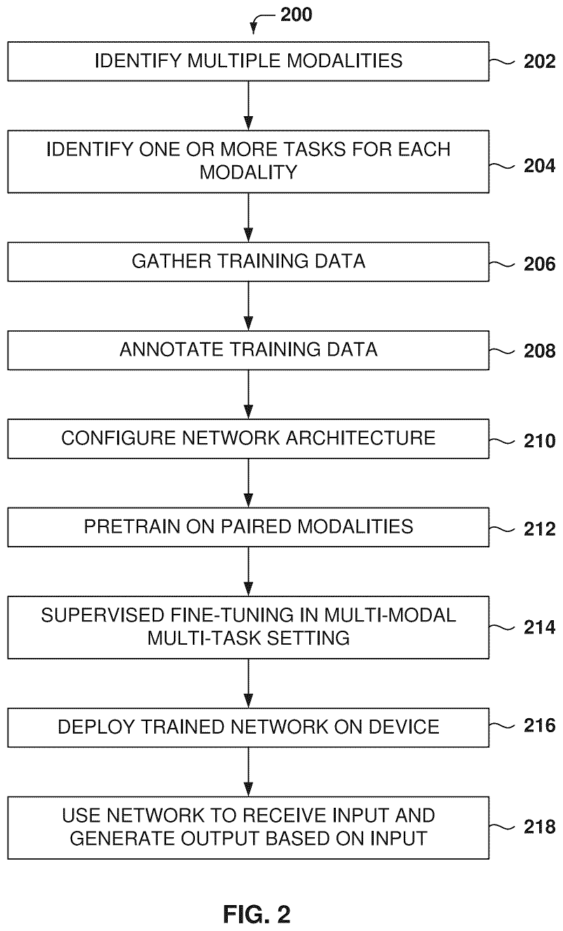

The unified transformer network (UTF) learns representations from multiple modalities through multimodality pretraining and multiple tasks, as depicted in FIG. 2 The process involves processing various modalities, each with its own set of tasks, such as image detection and segmentation or text-based sentiment classification. Training data is curated or annotated, and the network is configured and trained using designated algorithms. Once trained, the UTF is deployed to process inputs from specific modalities and produce task-based outputs.

The architecture may include an encoder-decoder structure with modality-specific organizers and shared components for cross-modality interactions. Pretraining commences with paired modalities, followed by supervised fine-tuning in a multimodal, multi-task setting. The trained UTF is then deployed on a computing device and utilized to receive inputs and generate outputs for various tasks.

A pretraining network is presented with an encoder-decoder structure. The encoder processes inputs from two distinct modalities, integrating information via a shared backbone composed of cross-attention blocks and transformer blocks. The encoder and decoder mirror each other's structure, with shared weights and cross-attention mechanisms for effective cross-modal information utilization. Tokens are used to process different types of inputs, with examples provided for text, image, video, and audio tokens.

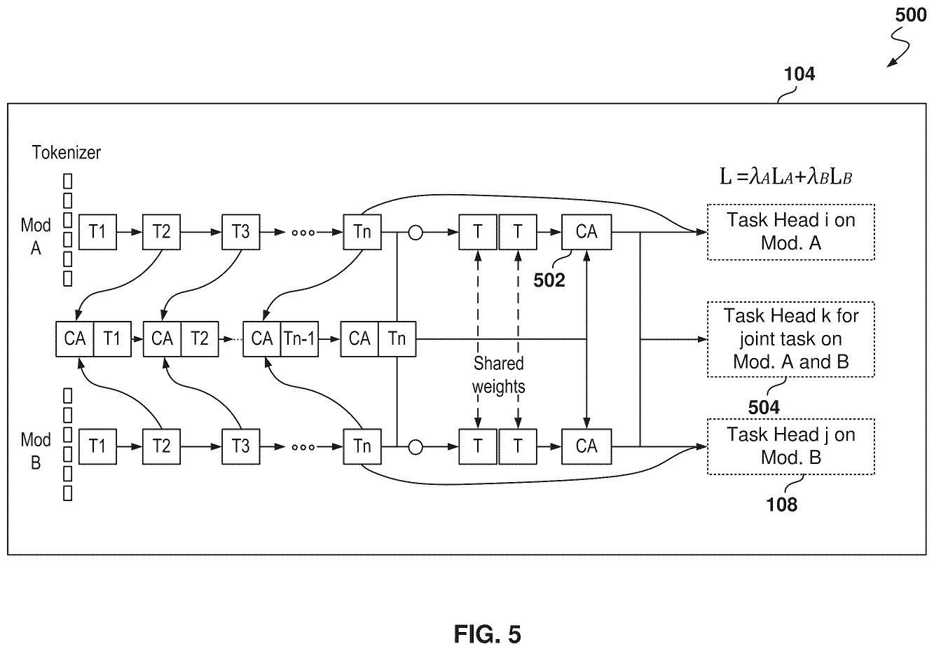

Pretraining the encoder-decoder network involves pretraining on paired modalities and pretraining on random modality pairs. The pretraining objective balances reconstruction losses for each modality and the shared network components. Fine-tuning the pre-trained model on multiple modalities and tasks is depicted in FIG. 5. Task heads for each modality and joint tasks are used to make predictions for different tasks. Fine-tuning the pre-trained model on multiple modalities and tasks includes task-specific fine-tuning and training on a joint task with a joint task head. The fine-tuning objective incorporates losses associated with individual and joint tasks, optimizing the network's performance and generalization across modalities.

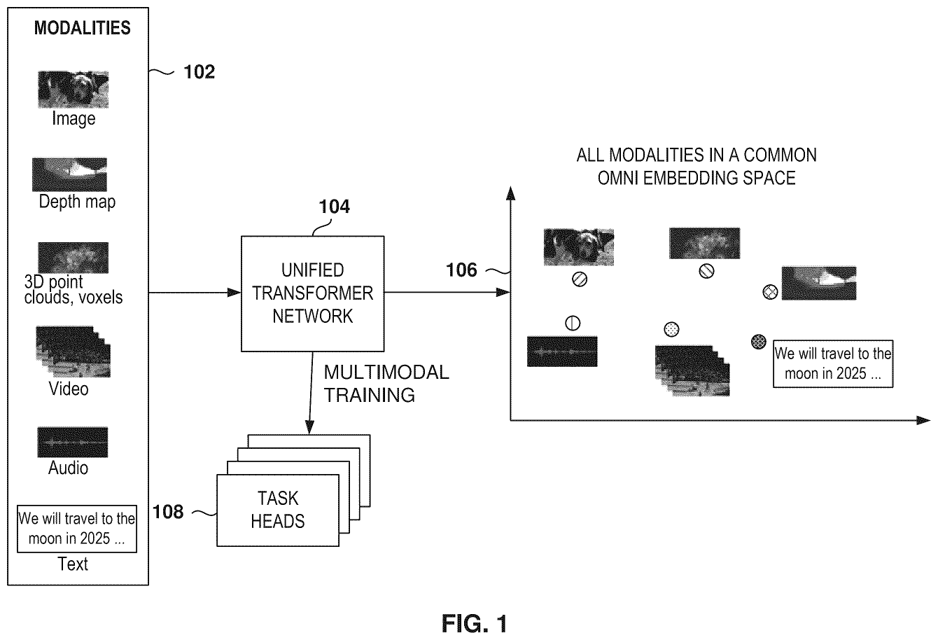

FIG. 1 illustrates the process of creating a unified transformer network (UTF) for learning representations from multiple modalities using multimodality pretraining and multiple tasks, according to some examples. The created UTF is used to make predictions or provide estimates for a plurality of tasks associated with a plurality of modalities.

In some examples, the knowledge of multiple modalities 102 is shared to embed the modalities 102 in a common embedding space 106 and to create task heads 108 for a variety of tasks.

To address diverse tasks, the network includes task-specific heads for unimodal objectives, as well as joint task heads for cross-modal tasks. Each task head is equipped with a loss function tailored to the respective task type. For instance, classification tasks employ cross-entropy loss, segmentation tasks rely on pixel-wise losses, and video text retrieval tasks utilize contrastive losses.

A task refers to a specific problem or objective that the Al model is designed to address. Some examples of tasks include classification (e.g., assigning a label to each input from a set of predefined categories, such as identifying spam emails and classifying images of animals), regression (e.g., predicting a continuous value based on input data, such as forecasting stock prices), clustering (e.g., grouping a set of inputs into clusters, where inputs in the same cluster are more similar to each other than to those in other clusters, such as customer segmentation or organizing a collection of news articles by topic), dimensionality reduction, anomaly detection (e.g., identifying unusual or rare items, events, or observations, such as fraud detection), reinforcement learning (e.g., learning an optimal policy or behavior through trial and error interactions with an environment, such as training a robot to navigate a maze), provide a recommendation (e.g., suggesting items to users based on their preferences and behaviors, such as suggesting products on an e-commerce platform), Natural Language Processing (NLP) (such as determining the sentiment (positive, negative, neutral) of a text), computer vision tasks (e.g., analysis of visual data, such as object detection to identify and localize objects within an image, or image segmentation to divide an image into segments or regions based on characteristics).

The modalities 102 may include any combination of images, depth maps, 3D point clouds, videos, audio, text, etc. Although some examples are presented with reference to the subset of their modalities 102, the principles presented herein may be applied to combinations of the modalities 102.

The UTF 104 is trained on multiple modalities 102 sequentially, allowing the embeddings (e.g., vectors) to generalize across modalities. Further, the result of the training is a trained UTF that includes task heads for performing multiple tasks. An example of the UTF 104 is described below with reference to FIG. 5.

Further, tasks are learned together with the unified UTF 104, which leads to regularization effects as a large number of shared parameters are trained to perform varied tasks and, hence, are more likely to extract meaningful representations from data without overfitting to one task or modality.

Learning tasks together also aids in utilizing available labeled data from different domains, hence potentially eliminating the cost and effort of labeling large amounts of data in a specific modality for a specific task. With the ability to share knowledge from multiple modalities 102 from different domains (e.g., visual, acoustic, textual), the modality-agnostic learning frameworks have been shown to provide better robustness than traditional unimodal networks.

The embeddings represent data points from the various modalities 102 that are converted into vectors. One characteristic of these embedding vectors is that if two input data points from the same modality (e.g., two images of cats) are used, the resulting embeddings should be close to each other, indicating a smaller distance between them than in the case where the two data points are not related to each other. Further, if two items from different modalities (e.g., a video and a text transcript of the video) are related, the embeddings will be close to each other; that is, the distance between the embeddings will be smaller than the distance between the embeddings if the two items were not related.

Some existing methods use a single source of information to train their models. For example, to teach a machine to recognize images, a large dataset of images is used to train the model. However, this approach only allows the model to learn from a single modality.

To work with multiple modalities simultaneously, a training strategy is presented that allows leveraging knowledge from multiple modalities while the UTF 104 is trained.

One advantage of utilizing a multimodal approach is the ability to leverage information from different modalities to enhance predictive performance. By jointly learning tasks across multiple modalities, such as depth images and RGB data for object detection, a synergistic effect can be achieved, leading to improved overall performance through cross-modality interactions.

Furthermore, the benefits of multimodal learning extend to optimizing performance in individual modalities. In cases where acquiring additional data for a specific modality may be challenging, leveraging existing data from other modalities is beneficial. By combining data from multiple modalities in training, it is possible to enhance performance without the need for extensive data collection efforts.

Experiments showed that the use of multiple modalities, such as image and text, to learn embeddings can be beneficial and improve performance and accuracy. The results showed that the performance was superior to methods that only utilized text, which indicates that the approach is capable of extrapolating information from other modalities.

FIG. 2 is a flowchart of a method 200 for implementing a unified transformer network for learning representations from multiple modalities using multimodality pretraining and multiple tasks, according to some examples.

The high-level process involves working with multiple modalities, each with training data for various tasks. For instance, the image modality may include tasks such as detection and segmentation, while the text modality may involve tasks like noun segmentation, sentiment classification, or emotion detection. Training data is either curated or annotated. Once the training data is available, a network is set up using a specified program, and the network is trained with the designated algorithms. After training, the UTF is deployed on the device to accept input from specific modalities and produce outputs based on the tasks defined in the training data.

Operation 202 is for identifying multiple modalities that will be addressed by the UTF.

From operation 202, the method 200 flows to operation 204 to identify one or more tasks for each modality, e.g., specifying the tasks or objectives that the UTF should perform for each modality. This operation ensures that the UFT aligns with the desired outcomes for each type of task.

From operation 204, the method 200 flows to operation 206 to gather the training data for the training of the UTF.

From operation 206, the method 200 flows to operation 208 to annotate the training data, which involves labeling the gathered data to be used with supervised learning. Annotations provide the ground truth that the network will use to learn the correct representations and outputs.

From operation 208, the method 200 flows to operation 210 to configure the network architecture, which is where the structure of the UTF is established, including the layers, connections, and parameters that will define how the network processes and learns from the data. In some examples, the network architecture includes an encoder-decoder structure comprising organizers specific to each modality and shared components for cross-modality interactions. The network architecture implements a three-stream architecture with unique and shared blocks to tokenize inputs from different modalities.

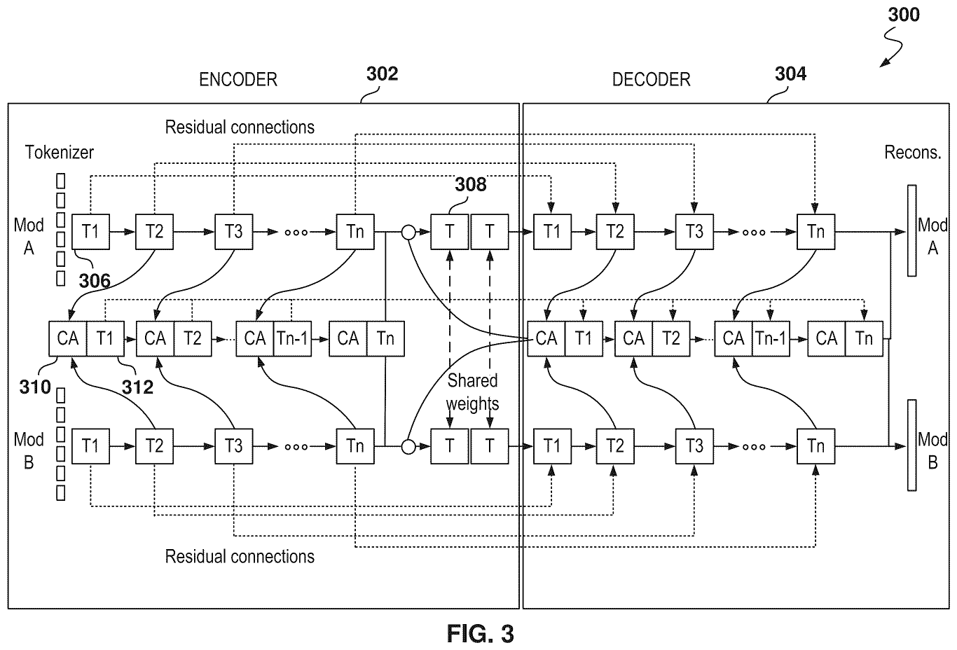

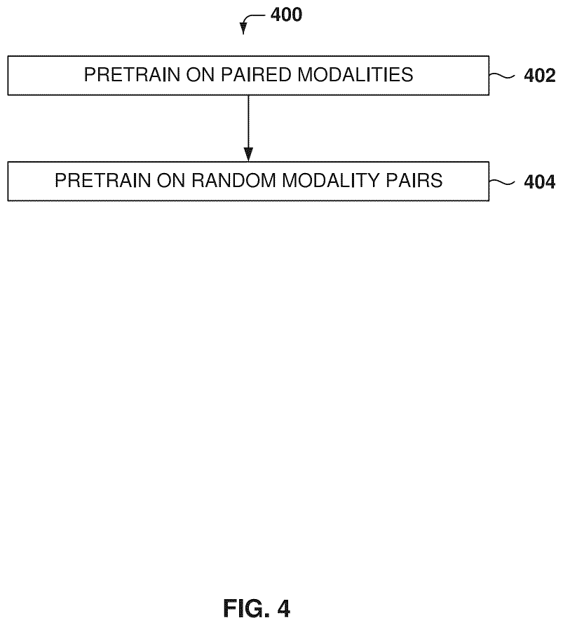

Pretraining begins with operation 212 to pre-train on paired modalities, where the network is initially trained on tasks that involve multiple modalities simultaneously. This operation allows the network to learn joint representations that capture the relationships between different types of data. More details on the pretraining are provided below with reference to FIGS. 3 and 4

The dual-stage pretraining strategy first aligns ordered modality pairs (e.g., RGB-Depth) to establish structured inter-modal relationships before introducing random pairings. This incremental alignment yields robust cross-modal representations while preserving domain-specific details, avoiding the pitfalls of overly early or late fusion. The fused features are gradually refined through cross-attention layers, ensuring neither modality-specific encoding nor unified representations dominate prematurely.

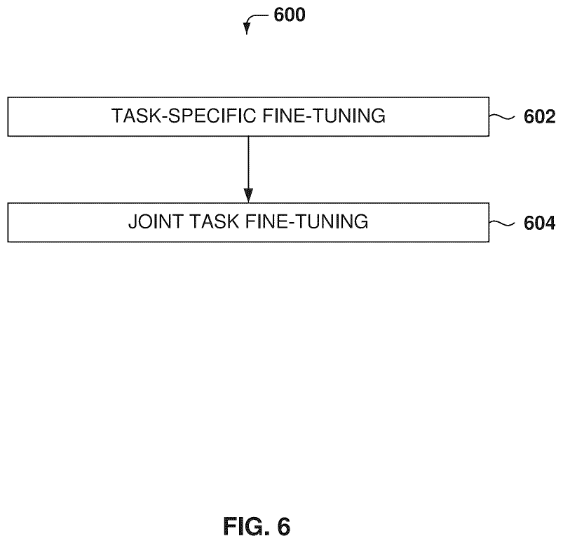

From operation 212, the method 200 flows to operation 214 for supervised fine-tuning in a multimodal, multi-task setting, which is the process of refining the UTF's performance on specific tasks through additional training. More details on the pretraining are provided below with reference to FIGS. 5 and 6.

From operation 214, the method 200 flows to operation 216 to deploy the trained UFT network on a computing device, that is, to integrate the UFT into a working environment where it is utilized for practical applications.

Operation 218 is where the UTF is used to receive inputs and generate outputs based on the received inputs for the different tasks.

FIG. 3 shows a pretraining network 300 with an encoder-decoder network, according to some examples. The network includes tokenizers that convert raw data into embeddings tailored to various data types, such as text, images, videos, audio, and point clouds. These embeddings are passed to dual transformer streams that independently process paired modalities, leveraging self-attention and feed-forward layers to capture intra-modality patterns. This ensures that essential modality-specific features are preserved before integration.

The pretraining network 300 consists of an encoder-decoder structure designed for pretraining. The pretraining network 300 includes an encoder 302 and a decoder 304, each consisting of multiple layers and components that work in tandem to encode input data into a latent representation and subsequently decode it for various tasks such as reconstruction, translation, or generation.

The encoder 302 processes inputs from two distinct modalities (e.g., modality A and modality B in the illustrated example), each represented by a dedicated backbone transformer network for each modality, along with a shared backbone network (shown between the two backbone transformer networks) that integrates information from both modality-specific backbones.

Each modality m is processed using a dedicated tokenizer Tₘ to convert raw inputs Xₘ into token embeddings Eₘ=Tₘ(Xₘ). The tokenizers are designed to cater to the specific characteristics of various data types. For instance, textual data uses byte-pair encoding, while visual data, including RGB and infrared images, is processed through patch tokenization. Video data employs space-time patch tokenization, and point clouds leverage methods from Point-BERT. Audio spectrograms are tokenized similarly to images, while time-series and tabular data are handled using Autoformer and TabTransformer, respectively. This modular tokenizer design ensures efficient and modality-specific processing, producing embeddings tailored for transformer-based representations.

The shared backbone is composed of a series of cross-attention (CA) blocks 310 and transformer blocks 312, which are followed by additional transformer blocks with shared weights between the two modalities. The outputs from the shared backbone and modality-specific backbones are fused using cross-attention mechanisms.

To preserve modality-specific patterns, the network employs two independent transformer streams, each dedicated to processing a paired modality. Given a modality m, token embeddings Eₘ are passed through L transformer layers:

$${H}_{m}^{( l )} = {TransformerLayer}^{( l )} ( {H}_{m}^{( l - 1 )} ) , l = 1 , ... , L$$

In this equation, the term

$${H}_{m}^{( l )}$$

represents the hidden state or feature representation of a specific modality m at the l^{th} layer of the transformer stream. Further,

$${H}_{m}^{( 0 )} = {E}_{m} .$$

Each layer comprises multi-head self-attention, feed-forward networks, layer normalization, and residual connections, ensuring stable training and efficient gradient flow. The streams operate independently without weight sharing, retaining essential intra-modality features and preventing premature fusion.

The shared transformer backbone facilitates cross-modal integration using cross-attention mechanisms, dynamically aligning and merging features from the dual streams. This design balances the preservation of modality-specific details with the creation of unified representations.

The shared transformer backbone integrates modality-specific features from the dual streams using cross-attention mechanisms. At the k^{th} layer, cross-attention dynamically aligns and merges features, as follows:

$${Z}^{( k )} = CrossAttn ( {H}_{A}^{( k + 1 )} , {H}_{B}^{( k + 1 )} )$$

In this equation, Z^{(k)} represents the cross-modal representation, passed through subsequent transformer layers for hierarchical refinement. The term

$${H}_{A}^{( k + 1 )}$$

represents the hidden state or feature representation of modality A at the (k+1)^{th} layer of the dual transformer stream before being passed to the cross-attention mechanism in the shared backbone.

Unlike traditional approaches that directly fuse feature embeddings, the shared backbone progressively aligns high-level representations. This design enables the network to capture fine-grained cross-modal dependencies while preserving modality-specific features.

Toward the end of the dual transformer streams, shared transformer blocks further refine the unified representations, enabling smooth transitions from independent modality processing to cross-modal fusion. These blocks use weight sharing and cross-attention layers to ensure efficient knowledge transfer across modalities. Specifically, each dual transformer stream has its own parameters and does not share weights with the other stream. The shared backbone is a separate, fully independent set of parameters responsible for cross-modal alignment.

In some examples, these blocks share weights and apply cross-attention mechanisms as follows:

$${H}_{shared} = T ( CrossAttn ( {H}_{A}^{( L )} , {H}_{B}^{( L )} ) )$$

Further, H_{shared} is the output of the shared transformer backbone, which integrates features from multiple modalities (e.g., modality A and modality B) and represents a cross-modal embedding that captures relationships and dependencies between the two modalities.

This arrangement ensures effective feature alignment, enabling robust knowledge transfer between modalities. The shared blocks provide a seamless transition from independent modality-specific representations to unified cross-modal embeddings suitable for downstream tasks.

A transformer is a type of deep learning model that is particularly effective for handling sequential data, such as text, speech, or time-series data. The transformer includes a self-attention mechanism. For text, the transformer allows the model to weigh the importance of different words in a sentence when constructing representations for each word, and it enables the model to consider the context of a word by looking at all other words in the sentence simultaneously.

The encoder 302 tokenizes each modality and passes the tokens through their respective modality streams and the shared stream. The output from the encoder 302 is then fed into the decoder 304, which mirrors the structure of the encoder with skip connections. Intermediate outputs from T₁-Tₙ are also fed into the decoder 304, maintaining symmetry between the encoder and decoder components.

The decoder 304 mirrors the structure of the encoder 302, maintaining three backbone networks with residual connections from the encoder. The shared decoder is fused with modality-specific decoders through cross-attention to ensure effective cross-modal information utilization.

The encoder 302 is responsible for processing input data from multiple modalities (e.g., modality A and modality B, as depicted). The input data is tokenized and passed through a series of transformer blocks 306 labeled T₁ through Tₙ, where ‘n’ represents the number of transformer blocks in the sequence. These transformer blocks 306 are interconnected with residual connections, which help preserve information and gradients throughout the layers.

Each transformer block within the encoder 302 may include components such as multi-head self-attention mechanisms and feed-forward neural networks. The output from the final transformer block Tₙ in the encoder 302 is then passed to the decoder 304, where parameters are shared between the encoder 302 and the decoder 304.

The middle row in the encoder 302 is a common element that serves to connect different modalities and understand the relationships between the tokens. This middle row acts as a bridge between the two modalities, focusing on learning the shared aspects among them.

The T blocks 308 are weights shared across the two modalities; that is, the T block 308 on the top row and the bottom row are the same. This sharing of weights implies that they are passed through a common pathway, enhancing the overall efficiency of the system. Although visually separated in the representation, the two sets of T blocks 308 could also be represented as a single entity shared by both chains.

The decoder 304 mirrors the encoder in structure, with its own sequence of transformer blocks T₁ through Tₙ. The decoder 304 reconstructs the input data based on the encoded representation. The decoder 304 also handles input from multiple modalities and includes residual connections within its transformer blocks to facilitate effective learning and information flow.

The output of the encoder is the same as the input of the encoder. It is similar to a phone system in which the audio at the source is encoded into a digital signal. Then, the audio is decoded at the destination as an audio signal again.

A token is a unit of data used for processing different types of inputs. Each mode item may be tokenized differently. Here are some examples of tokens across various data types:
Text Tokens are units of meaning in textual data. They may include word tokens (individual words or terms), subword tokens (parts of words), and character tokens.
Image tokens are units of information in image data, often representing patches or pixels. Examples include pixel tokens (e.g., individual pixels in an image, each with values for color channels (e.g., RGB)) and patch tokens (e.g., segments of the image divided into smaller patches).
Video tokens are units of information in video data, typically frames or segments of frames. Examples include frame tokens (individual frames extracted from a video sequence, e.g., a 30-second video at 30 fps would have 900 frame tokens) and spatiotemporal tokens (segments that capture both spatial and temporal information, such as 3D as 3d patches or clips, e.g., a video clip might be divided into segments of 16×16×16 pixels over time).
Audio tokens are units of information in audio data, representing segments of the audio waveform. Examples include time-domain tokens (e.g., small segments of the audio waveform) and frequency-domain tokens (e.g., segments representing frequency components, such as an audio signal transformed into spectrograms, with each time-frequency bin acting as a token).

The tokens are encoded into a vector representation. In some examples, the vector representation includes the type of modality (I), size of temporal dimension (T), height (H), width (W) in spatial dimension, number of channels (C), and length or number of tokens (L), but other examples may include different vector representations.

Tokens serve to divide the input into smaller units. For text modalities, a long sentence can be segmented into tokens, where each token represents a distinct part of the input. Similarly, in the case of images, dividing the image into smaller squares using a grid results in each square becoming a token. For instance, a 4×4 grid applied to an image would yield 16 small images, each serving as a token.

FIG. 4 is a flowchart of a method 400 for pretraining the encoder-decoder network, according to some examples. The network training procedure is designed to effectively balance modality-specific feature extraction with cross-modal integration. Pretraining involves two stages. The training begins with a dual-stage pretraining phase using an encoder-decoder network, which leverages masked reconstruction objectives to capture shared and modality-specific representations. This is followed by multi-task fine-tuning aimed at optimizing performance across downstream applications.

In the first stage, the model learns structured relationships from ordered modality pairs, such as RGB and Depth. In the second stage, random modality pairings enhance robustness to diverse scenarios. Reconstruction losses for both modality-specific and shared components guide the learning process. The encoder-decoder structure uses residual connections to facilitate effective information flow and accurate reconstruction of masked inputs, ensuring robust feature learning.

Initially, the model is pre-trained on paired modalities, where both modalities are tasked with the same objective or a retrieval task where one modality searches within another. An example of paired modalities is the scenario of an autonomous car equipped with both lidar sensors and cameras performing object detection on the same scene. The two stages during pretraining are represented by operations 402 and 404.

Operation 402 is for pretraining on paired modalities. The process begins with a small, paired dataset to pretrain the network while maintaining ordered correspondences between the modalities (e.g., modalities A and B). Initially, the pretraining is performed with an ordered pair of input modalities. After a fixed number of epochs, the pairs are randomly switched if they belong to the same domain (e.g., three-channel images such as RGB and Depth images). For other combinations, the ordered pairing is maintained without random switching. The tokenizer is also switched when the modality is switched.

During pretraining, the encoder-decoder structure facilitates masked token reconstruction. The encoder processes tokenized inputs through the dual transformer streams and shared backbone, generating hidden representations:

$${H}_{e n c} = SharedBackbone ( {H}_{A} , {H}_{B} )$$

The term H_{enc} refers to the encoded representation or hidden state generated by the shared backbone during the pretraining phase of the unified transformer network and represents the integrated features from multiple modalities after processing through the shared backbone.

The decoder mirrors the encoder, incorporating skip connections between corresponding encoder and decoder layers:

$${H}_{dec}^{( l )} = {DecoderLayer}^{( l )} ( {H}_{dec}^{( l - 1 )} + {H}_{enc}^{( l )} )$$

The term

$${H}_{d e c}^{( l )}$$

refers to the hidden state or feature representation at the l^{th} layer of the decoder in the encoder-decoder structure and represents the progressively refined features during the decoding process, which reconstructs masked inputs or generates outputs based on the encoded representation

$${H}_{e n c}^{( l )}$$

and skip connections from the encoder.

The skip connections ensure that high-resolution modality-specific features are preserved throughout the reconstruction process. Cross-attention within the decoder integrates the outputs from the shared backbone and the final dual stream layers, enabling accurate reconstruction of masked features for each modality.

From operation 402, the method 400 flows to operation 404 to pre-train on random modality pairs. Modality pairs are selected randomly, and the pretraining continues without assigning a specific encoder to a particular modality. Operation 404 ensures that the network becomes adept at handling a wide variety of modality combinations, enhancing its robustness and flexibility.

The network is pretrained using a dual-stage masked reconstruction strategy to learn robust and generalized multimodal representations. During the first stage, the network is trained on ordered modality pairs (e.g., RGB and Depth) to establish structured relationships, while the second stage employs random modality pairings to enhance adaptability and robustness. The encoder-decoder structure reconstructs masked inputs while preserving both modality-specific and shared features. The loss function [symbol] ₚᵣₑₜᵣₐᵢₙ for pretraining is defined as:

$${ℒ}_{pretrain} = {λ}_{A} {ℒ}_{rec , A} + {λ}_{B} {ℒ}_{rec , B} + {λ}_{shared} {ℒ}_{shared}$$

In this pretraining objective, [symbol] _{rec,A} and [symbol] _{rec,B} are reconstruction losses for modalities A and B, and [symbol] _{shared} is the loss for the shared network components. Further, λ_{A}, λ_{B}, and λ_{shared} are weights used as hyperparameters to balance the contributions of each component.

FIG. 5 illustrates a process 500 of fine-tuning the pre-trained model on multiple modalities and multiple tasks, according to some examples. After pretraining, the network undergoes further training using supervised learning on multiple modalities and tasks, as illustrated in FIG. 5. The training includes two stages, as described below, in reference to FIG. 6.

Fine-tuning adapts the pretrained network to various downstream tasks using task-specific and joint task heads. Task-specific heads are optimized for unimodal tasks like classification and segmentation, while joint task heads address cross-modal objectives such as video-text retrieval. Fine-tuning proceeds in two phases: the first phase focuses on task-specific heads, and the second phase optimizes joint task heads for paired tasks. A task balancing strategy ensures consistent performance across different applications.

The UTF 104 has a similar structure to the encoder 302 and includes a tokenizer for each modality. The input data from modality A and modality B are passed through a series of transformer blocks labeled T₁ through Tₙ, where ‘n’ represents the number of transformer blocks in the sequence.

The encoded representations from both modalities are then fed into a shared central processing unit comprising the T blocks, which have shared weights. The central chain allows for the integration of information from both modalities and enables the model to learn shared representations that are beneficial for multiple tasks.

The T blocks are inputs for the cross-attention (CA) blocks 502, and the output of the CA blocks 502 is the input for the respective task heads 108. In some examples, the task heads include a task head for each modality and a task head for joint tasks on both modalities.

The task head for modality A is designed to fine-tune the model for a specific task related to modality A, and the task head for modality B is similarly tasked with fine-tuning the model for a task specific to modality B. Additionally, the task head 504 is responsible for a joint task that leverages the combined information from both modality A and modality B. Each task head is associated with the corresponding loss function [symbol] .

The resulting trained UTF 104, including the task heads, is then used to make estimates or predictions for the different tasks and the different modalities. The task head is responsible for taking input during operation and producing an output.

The inference phase leverages the shared backbone for scalable deployment, allowing the model to operate in unimodal or multimodal modes depending on the task. This flexibility ensures adaptability without compromising performance. By combining modality-specific and cross-modal learning, the framework achieves robust, unified representations, enabling effective and versatile multimodal task execution.

In an example scenario where the task is to identify a car in an image, the image is provided as input (modality A) to the network. The network then produces an output, which could be a bounding box indicating the location of the car in the image or a pixel-wise color segmentation outlining the car's extent. The type of output generated depends on the specific task, which could range from scene-level classification (e.g., determining if the image contains a car) to box-level detection or pixel-level segmentation.

Another example is for the analysis of a product image, where the system uses the product image to be embedded in other images, such as images created using Generative Artificial Intelligence (GAI). The product image provided will include a background, and the goal is to separate the product from the background. The first task is to identify the product within the image. This identification process is referred to as semantic segmentation, where each pixel corresponding to the object is identified. Once the object is segmented, it can be extracted and placed in a new scene or image.

FIG. 6 is a flowchart of a method 600 for fine-tuning the pre-trained model on multiple modalities and multiple tasks, according to some examples. Following pre-training, the next stage is supervised fine-tuning.

The structured fine-tuning procedure is aimed at optimizing both task-specific and joint-task objectives. The fine-tuning process is conducted in two phases, with each phase addressing distinct aspects of task adaptation and integration.

During pre-training, the focus is on encoding and decoding to achieve the same output. Tasks are introduced during supervised fine-tuning, such as predicting sentiment in text or detecting objects in images. Fine-tuning may involve tasks on single modalities (A and B) as well as joint tasks, where multiple modalities are considered together. An example of a joint task is object detection using both RGB images and corresponding depth images.

The supervised fine-tuning in a multimodal multi-task setting includes two stages represented by operations 602 and 604. Operation 602 is for task-specific fine-tuning. At operation 602, task-specific heads are fine-tuned for unimodal tasks, focusing on extracting and optimizing modality-specific features learned during pretraining. For a given modality m, the associated task-specific head TaskHead_{m,i} is trained using an objective function tailored to the downstream task. Examples include cross-entropy loss for classification tasks, pixel-wise reconstruction loss for segmentation, and regression-based objectives for depth estimation. During this phase, the dual transformer streams and shared backbone weights are frozen, allowing the task-specific head to adapt without disrupting the pre-trained modality-specific representations.

The task loss [symbol] ₘ for a modality m is represented as:

$${ℒ}_{m} = \frac{1}{{N}_{m}} {\sum }_{i = 1}^{{N}_{m}} {ℒ}_{( {\hat{𝓎}}_{m , i} , {𝓎}_{m , i} )}$$

In this equation, [symbol] _{m,i} and [symbol] _{m,i} denote the predicted and ground truth outputs for task i, respectively, and Nₘ is the number of tasks associated with the modality. Nₘ is used to normalize the total loss for modality m by dividing the sum of losses across all tasks by the number of tasks. This ensures that the loss is averaged over all tasks, preventing any single task from disproportionately influencing the training process.

The term [symbol] represents the loss function for the i^{th} task associated with modality m and measures the difference between [symbol] _{m,i} and [symbol] _{m,i}. This loss function [symbol] quantifies how well the network predictions match the ground truth for a specific task and is used to optimize the network parameters during fine-tuning.

Initially, two modalities are randomly assigned to modality A and modality B. Two task heads are attached to each modality-specific transformer network. The network is trained for a few epochs with these individual task heads.

During operation 604, a pair of modalities with a joint task is selected. The network fine-tunes the joint-task heads to handle cross-modal objectives, such as video-text retrieval or image-audio pairing. These tasks require effective integration of multi-modal features from the shared backbone.

The joint task head TaskHead_{joint,k} processes concatenated or aligned feature representations from the shared transformer backbone, optimizing for objectives such as retrieval metrics (e.g., Recall@K) or contrastive alignment losses.

The joint task loss [symbol] ⱼₒᵢₙₜ is defined as:

$${ℒ}_{j o i n t} = \frac{1}{{N}_{joint}} {\sum }_{k = 1}^{{N}_{j o i n t}} {ℒ}_{align ( {\hat{𝓎}}_{joint , k} , {𝓎}_{jint , k} )}$$

In this equation, [symbol] _{joint,k} is the predicted output for the kₜₕ joint task (e.g., a predicted embedding or similarity score for a multimodal task). Further, [symbol] _{joint,k} is the ground truth output for the kₜₕ joint task (e.g., the actual similarity score or label for the multimodal task). [symbol] is a loss function that quantifies the error or discrepancy between [symbol] _{joint,k} and [symbol] _{joint,k}, and is used to optimize the ability of the network to align and integrate features from multiple modalities, ensuring that the network learns meaningful relationships between modalities in order to perform joint tasks effectively. In some examples, [symbol] _{align} is the cosine similarity for aligning multimodal representations.

During this phase, the shared transformer backbone is fine-tuned with a task-specific learning rate to improve cross-modal interactions while preserving previously learned intra-modal features.

The individual task heads are replaced with a joint task head that handles both modalities. The network is trained end-to-end on the joint task, ensuring that the learned representations are effectively utilized for the joint objective.

The overall fine-tuning objective combines modality-specific and joint-task losses as follows:

$${ℒ}_{fine - tune} = {λ}_{A} {ℒ}_{A} + {λ}_{B} {ℒ}_{B} + {λ}_{joint} {ℒ}_{joint}$$

The term [symbol] _{fine-tune} represents the overall fine-tuning loss function used during the fine-tuning phase of the unified transformer network and combines the losses from modality-specific tasks and joint tasks to optimize the network's performance across both unimodal and multimodal objectives. Further, [symbol] ⱼₒᵢₙₜ is the loss associated with the joint task head. The hyperparameters λ_{A}, λ_{B}, and λⱼₒᵢₙₜ control the relative importance of individual and joint-task objectives. In some examples, these weights are tuned using grid search or adaptive balancing techniques to ensure consistent performance across tasks and modalities.

By adopting this two-stage fine-tuning approach, the network is not only tailored to perform well on individual modality-specific tasks but also learns to leverage shared representations for joint tasks, thereby improving overall performance and generalization.

The fine-tuned model may be used for the inferencing phase. The inference phase leverages the flexibility and modularity of the network to accommodate both single-stream and multimodal configurations, ensuring efficient deployment across a variety of tasks and modalities. The inference process is designed to capitalize on the shared transformer backbone and pre-trained representations to achieve robust performance with minimal computational overhead.

For tasks involving a single modality, such as image classification or audio event detection, the network operates in a single-stream mode. In this configuration, one of the dual transformer streams is retained, while the shared transformer backbone remains active to refine the representations.

Given an input Xₘ from modality m, the associated token embeddings Eₘ=Tₘ(Xₘ) are processed through the corresponding transformer stream to extract modality-specific features:

$${H}_{m} = DualTransformerStream ( {E}_{m} )$$

The term Hₘ is the intermediate representation of the input data for modality m (e.g., text, image, audio, video, etc.) as it is processed through the modality-specific transformer stream.

These features are further refined by the shared transformer backbone Z=SharedBackbone (Hₘ) and passed to the task-specific head for prediction [symbol] ₘ=TaskHeadₘ(Z).

This setup ensures that the shared backbone enhances intra-modal patterns while maintaining computational efficiency by bypassing the unused transformer stream.

For tasks requiring cross-modal interactions, such as video-text retrieval or RGB-depth segmentation, the network processes multiple modalities simultaneously. Inputs from paired modalities X_{A} and X_{B} are tokenized and passed through their respective transformer streams:

$${H}_{A} = {DualTransformerStream}_{A} ( {T}_{A} ( {X}_{A} ) )$$

$${H}_{B} = {DualTransformerStream}_{B} ( {T}_{B} ( {X}_{B} ) )$$

The shared transformer backbone integrates these modality-specific features using cross-attention mechanisms:

$${Z}_{joint} = SharedBackbone ( CrossAttn ( {H}_{m} , {H}_{B} ) )$$

The term Zⱼₒᵢₙₜ is the output of the shared transformer backbone after processing the hidden states from multiple modalities (e.g., Hₘ and H_{B}) through cross-attention mechanisms and represents a unified embedding that combines modality-specific features into a single representation suitable for joint tasks. The result is a unified representation suitable for joint tasks. The joint task head then generates the final prediction based on Zⱼₒᵢₙₜ:

$${joint}_{} = {TaskHead}_{j oint} ( {Z}_{joint} )$$

This configuration enables the network to dynamically align and merge information from multiple modalities, facilitating robust performance in cross-modal applications.

Some details of example implementations are described below. For modality-specific processing, the tokenizers include: for text, BPE encoding; for image and video, Patch; for point cloud, Point-BERT; and for audio, Spectrogram. Further, the inference modes comprise single-stream (One active modality), multimodal (parallel streams+backbone), and missing modality (mean-pooled embeddings).

For shared components, the backbones included cross-attention (4 layers), shared transformer (2 layers), and cross-modal integration. The task heads included unimodal tasks and joint tasks, and the decoder includes six layers (pretraining). The training setup included a batch size of 64 for unimodal or 32 for cross-modal, and the Sequence was 256 for text and 196 tokens for Image. The stabilization included a gradient clip (1.0) with early stopping.

With M parameters, the network balances modality-specific processing (e.g., 90M parameters across tokenizers and dual streams) with cross-modal integration (e.g., 52M in the shared backbone). This design achieves parameter efficiency through weight sharing in the backbone, enabling both single-stream and multimodal inference without re-training. The architecture supports dynamic modality configurations while maintaining consistent performance, demonstrating superior efficiency compared to previous multimodal approaches that require separate encoders or extensive adaptation between tasks.

For task and modality sampling, at each training iteration, a (task, modality) pair is randomly sampled from the multimodal dataset pool. The random scheduling consistently outperforms sequential or round-robin strategies by avoiding catastrophic forgetting and balancing data coverage. The GPUs process the same sampled pair per iteration to maintain synchronized gradient updates, and synchronized batch normalization (SyncBN) is employed across devices to preserve consistent batch statistics.

For the pretraining protocol, a two-stage masked pre-training procedure across diverse datasets (e.g., ImageNet-1K for images, Something-Something v2 for video, AudioSet for audio, English Wikipedia for text, SUN RGB-D for depth maps, and ModelNet40 for 3D point clouds) was used. In the first stage, modalities that share direct correlations were aligned (e.g., RGB-Depth), while the second stage randomizes pairings for enhanced robustness. Modality-specific masking strategies follow to promote effective reconstruction, and extended ablations on masking ratios and reconstruction objectives are provided in the supplementary.

After pretraining, during fine-tuning, the dual streams and shared backbone are frozen first, training task-specific heads (e.g., classification, segmentation) on unimodal tasks. Afterwards, joint task heads are fine-tuned for cross-modal tasks such as video-text retrieval or audio-video captioning. In some examples, the task heads are optimized using cross-entropy, contrastive, or segmentation-specific losses, and an uncertainty-based weighting scheme is used when multiple objectives co-exist. For classification tasks, SGD (momentum 0.9) was used with cosine annealing; segmentation tasks adopt A damW (weight decay 10⁻⁴); and retrieval tasks utilize a contrastive objective.

During evaluation of the inferencing, both single-stream (activating only the relevant modality stream) and multi-modal configurations (activating parallel streams, fused in the shared backbone) were supported. Mean-pooled embeddings were used to handle missing modalities without retraining.

In some testing, the model was evaluated on different data sets, such as image recognition (iNaturalist-8, Places), video recognition (Kinetics, Moments in Time), audio classification (ESC-50), 3D point cloud tasks (ModelNet40-C, S3DIS), text summarization (DialogueSUM), and multimodal QA (NextQA, MUSIC-AVQA, Clotho). Additional experiments included unseen datasets (e.g., HM DB51, Oxford-IIIT Pets, ScanObjectNN), cross-domain retrieval (YouCook2, MSR-VTT), cross-modal transfer (ADE20K, COCO), and new modalities (RegDB, ETTh1, PCQM 4M-LSC, Ego4D).

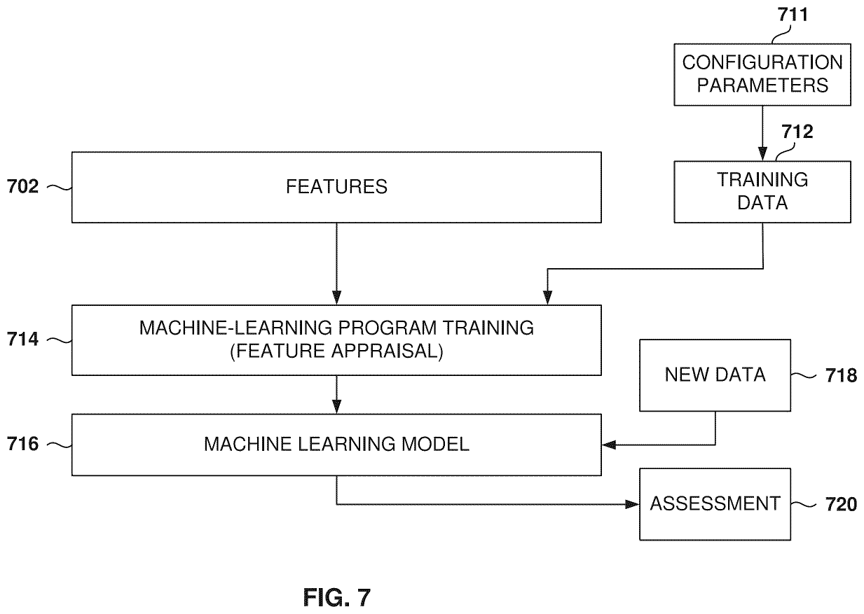

FIG. 7 illustrates the training and use of a machine-learning model 716, according to some examples. In some examples, machine learning (ML) models 716 are utilized to perform multimodal tasks, such as object classification, object detection, text summarization, image recognition, scene recognition, action recognition, etc.

Machine Learning (ML) is an application that provides computer systems the ability to perform tasks without explicitly being programmed by making inferences based on patterns found in the analysis of data. Machine learning explores the study and construction of algorithms, also referred to herein as tools, which may learn from existing data and make predictions about new data. Such machine-learning algorithms operate by building an ML model 716 from training data 712 in order to make data-driven predictions or decisions expressed as outputs or assessments 720. Although examples are presented with respect to a few machine-learning tools, the principles presented herein may be applied to other machine-learning tools.

Data representation refers to the method of organizing the data for storage on a computer system, including the structure for the identified features and their values. In ML, it is typical to represent the data in vectors or matrices of two or more dimensions. When dealing with large amounts of data and many features, data representation is important so that the training is able to identify the correlations within the data.

There are two common modes for ML: supervised ML and unsupervised ML. Supervised ML uses prior knowledge (e.g., examples that correlate inputs to outputs or outcomes) to learn the relationships between the inputs and the outputs. The goal of supervised ML is to learn a function that, given some training data, best approximates the relationship between the training inputs and outputs so that the ML model can implement the same relationships when given inputs to generate the corresponding outputs. Unsupervised ML is the training of an ML algorithm, using information that is neither classified nor labeled and allowing the algorithm to act on that information without guidance. Unsupervised ML is useful in exploratory analysis because it can automatically identify structure in data.

Typical tasks for supervised ML are classification problems and regression problems. Classification problems, also referred to as categorization problems, aim to classify items into one of several category values (for example, is this object an apple or an orange?). Regression algorithms aim to quantify some items (for example, by providing a score for the value of some input). Some examples of commonly used supervised ML algorithms are Logistic Regression (LR), Naive-Bayes, Random Forest (RF), neural networks (NN), deep neural networks (DNN), matrix factorization, and Support Vector Machines (SVM).

Some typical tasks for unsupervised ML include clustering, representation learning, and density estimation. Some examples of commonly used unsupervised ML algorithms are K-means clustering, principal component analysis, and autoencoders.

Feature extraction is a process that reduces the amount of resources required to describe a large set of data. When performing analysis of complex data, one of the major problems stems from the number of variables involved. Analysis with a large number of variables generally requires a large amount of memory and computational power, and it may cause a classification algorithm to overfit training samples and generalize poorly to new samples. Feature extraction includes constructing combinations of variables to get around these large-data-set problems while still describing the data with sufficient accuracy for the desired purpose.

In some examples, feature extraction starts from an initial set of measured data and builds derived values (features) intended to be informative and non-redundant, facilitating the subsequent learning and generalization steps. Further, feature extraction is related to dimensionality reduction, such as reducing large vectors (sometimes with sparse data) to smaller vectors capturing the same or a similar amount of information.

The training data 712 comprises examples of values for the features 702. In some examples, the training data comprises labeled data with examples of values for the features 702 and labels indicating the outcome, such as information on the content of an image, bounding boxes, text corresponding to audio, text transcript for a video recording, etc. The machine-learning algorithms utilize the training data 712 to find correlations among identified features 702 that affect the outcome. A feature 702 is an individual measurable property of a phenomenon being observed. The concept of a feature is related to that of an explanatory variable used in statistical techniques such as linear regression. Choosing informative, discriminating, and independent features is important for the effective operation of ML in pattern recognition, classification, and regression. Features may be of different types, such as numeric, string, categorical, and graph. A categorical feature is a feature that may be assigned a value from a plurality of predetermined possible values (e.g., this animal is a dog, a cat, or a bird).

During training 714, the ML program, also referred to as ML algorithm or ML tool, analyzes the training data 712 based on identified features 702 and configuration parameters 711 defined for the training. The result of the training 714 is the ML model 716, which is capable of taking inputs to produce assessments.

Training an ML algorithm involves analyzing large amounts of data (e.g., from several gigabytes to a terabyte or more) in order to find data correlations. The ML algorithms utilize the training data 712 to find correlations among the identified features 702 that affect the outcome or assessment 720. In some examples, the training data 712 includes labeled data, which is known data for one or more identified features 702 and one or more outcomes, such as object classification, object detection, text summarization, image recognition, scene recognition, action recognition, etc.

The ML algorithms usually explore many possible functions and parameters before finding what the ML algorithms identify to be the best correlations within the data; therefore, training may make use of large amounts of computing resources and time.

Many ML algorithms include configuration parameters 711. The configuration parameters 711 define variables for an ML algorithm in the search for the best ML model. The training parameters include model parameters and hyperparameters. Model parameters are learned from the training data, whereas hyperparameters are not learned from the training data but are instead provided to the ML algorithm.

Some examples of model parameters include maximum model size, maximum number of passes over the training data, data shuffle type, regression coefficients, decision tree split locations, and the like. Hyperparameters may include the number of hidden layers in a neural network, the number of hidden nodes in each layer, the learning rate (perhaps with various adaptation schemes for the learning rate), the regularization parameters, types of nonlinear activation functions, and the like. Finding the correct (or the best) set of hyperparameters can be a time-consuming task that makes use of a large amount of computer resources.

When the ML model 716 is used to perform an assessment, new data 718 is provided as input to the ML model 716, which generates the assessment 720 as output.

In some examples, results obtained by the model 716 during operation (e.g., assessment 720 produced by the model in response to inputs) are used to improve the training data 712, which is then used to generate a newer version of the model. Thus, a feedback loop is formed to use the results obtained by the model to improve the model.

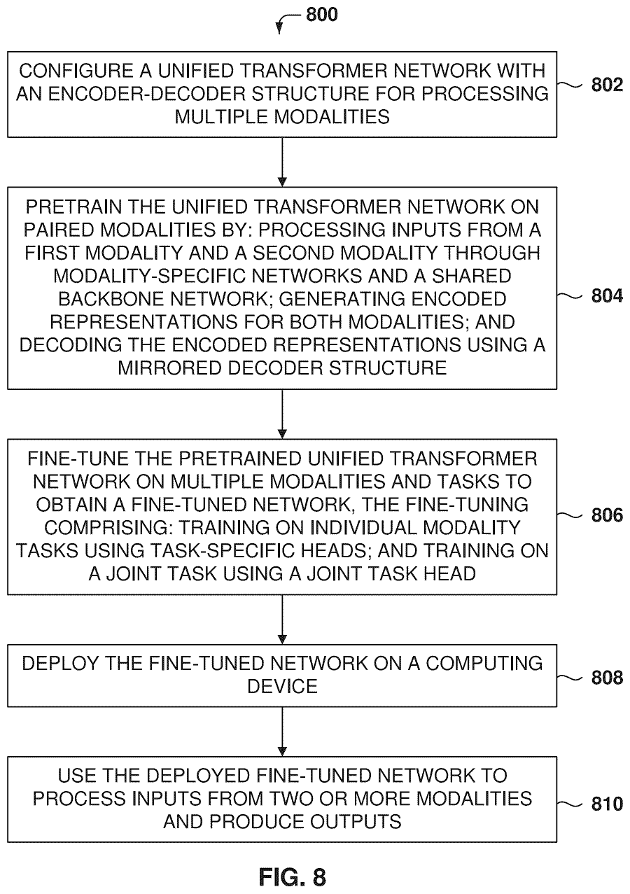

FIG. 8 is a flowchart of a method 800 for implementing a unified transformer network (UTF) for learning representations from multiple modalities. While the various operations in this flowchart are presented and described sequentially, one of ordinary skill will appreciate that some or all of the operations may be executed in a different order, be combined or omitted, or be executed in parallel.

Operation 802 is for configuring a unified transformer network with an encoder-decoder structure for processing multiple modalities. This configuration involves setting up the network architecture to handle different types of data inputs, such as images, text, audio, and video. The encoder-decoder structure is designed to facilitate the processing and integration of these diverse data types, allowing the network to learn and generate meaningful representations across modalities.

From operation 802, the method 800 flows to operation 804, where the unified transformer network undergoes pretraining on paired modalities. This pretraining involves processing inputs from a first modality and a second modality through modality-specific networks and a shared backbone network. The network generates encoded representations for both modalities, which are then decoded using a mirrored decoder structure.

From operation 804, the method 800 flows to operation 806, where the pretrained unified transformer network undergoes fine-tuning on multiple modalities and tasks to develop a fine-tuned network. The fine-tuning process includes training on individual modality tasks using task-specific heads and training on a joint task using a joint task head. This operation refines the network's ability to perform tasks associated with each modality while also enhancing the capability to handle tasks that require the integration of information from multiple modalities.

From operation 806, the method 800 advances to operation 808, which involves deploying the fine-tuned network on a computing device. Deployment allows the network to be utilized in practical applications, where the network can process real-world data inputs from multiple modalities and produce outputs based on the tasks the network has been trained to perform.

At operation 810, the deployed fine-tuned network is used to process inputs from two or more modalities and produce outputs. This operation demonstrates the network's ability to handle complex, multimodal data and deliver task-specific results, showcasing the effectiveness of the unified transformer network in integrating and leveraging information from diverse data sources.

In view of the disclosure above, various examples are set forth below. It should be noted that one or more features of an example, taken in isolation or combination, should be considered within the disclosure of this application.
Example 1. A method comprising: configuring a unified transformer network with an encoder-decoder structure for processing multiple modalities; pretraining the unified transformer network on paired modalities by: processing inputs from a first modality and a second modality through modality-specific networks and a shared backbone network; generating encoded representations for both modalities; and decoding the encoded representations using a mirrored decoder structure; fine-tuning the pretrained unified transformer network on multiple modalities and tasks to obtain a fine-tuned network, the fine-tuning comprising: training on individual modality tasks using task-specific heads; and training on a joint task using a joint task head; deploying the fine-tuned network on a computing device; and using the deployed fine-tuned network to process inputs from two or more modalities and produce outputs.
Example 2. The method of Example 1, wherein the encoder-decoder structure includes modality-specific organizers and shared components for cross-modality interactions.
Example 3. The method of any one or more of Examples 1-2, wherein the shared backbone network comprises cross-attention blocks and transformer blocks.
Example 4. The method of any one or more of Examples 1-3, wherein the mirrored decoder structure includes skip connections from the encoder.
Example 5. The method of any one or more of Examples 1-4, wherein the first modality and the second modality are selected from a group consisting of images, depth maps, 3D point clouds, videos, audio, and text.
Example 6. The method of any one or more of Examples 1-5, wherein fine-tuning the pretrained unified transformer network further comprises: optimizing a fine-tuning objective that incorporates losses associated with individual tasks and joint tasks.
Example 7. The method of any one or more of Examples 1-6, further comprising: tokenizing inputs from each modality before processing through the modality-specific networks.
Example 8. The method of any one or more of Examples 1-7, wherein tokenizing inputs comprises: for text modalities, segmenting text into word, subword, or character tokens; for image modalities, dividing images into pixel or patch tokens; for video modalities, extracting frame tokens or spatiotemporal tokens; and for audio modalities, segmenting audio into time-domain or frequency-domain tokens.
Example 9. The method of any one or more of Examples 1-8, wherein the unified transformer network is configured to share knowledge across multiple modalities to embed the modalities in a common embedding space.
Example 10. The method of any one or more of Examples 1-9, wherein the individual modality tasks include at least one of object classification, object detection, text summarization, image recognition, scene recognition, and action recognition.
Example 11. The method of any one or more of Examples 1-10, wherein the unified transformer network includes a three-stream architecture with unique and shared blocks to tokenize inputs from different modalities.
Example 12. The method of any one or more of Examples 1-11, wherein the unified transformer network is configured to generate embeddings for input data points, wherein related data points from a same modality have smaller distances between their embeddings compared to embeddings from other modalities.
Example 13. The method of any one or more of Examples 1-12, further comprising: applying the unified transformer network to at least one of: autonomous vehicle technology, product image analysis, and generative artificial intelligence tasks.
Example 14. The method of any one or more of Examples 1-13, wherein the unified transformer network is configured to leverage information from one modality to enhance performance in another modality.
Example 15. A system comprising: a memory comprising instructions; and one or more computer processors, wherein the instructions, when executed by the one or more computer processors, cause the system to perform operations comprising: configuring a unified transformer network with an encoder-decoder structure for processing multiple modalities; pretraining the unified transformer network on paired modalities by: processing inputs from a first modality and a second modality through modality-specific networks and a shared backbone network; generating encoded representations for both modalities; and decoding the encoded representations using a mirrored decoder structure; fine-tuning the pretrained unified transformer network on multiple modalities and tasks to obtain a fine-tuned network, the fine-tuning comprising: training on individual modality tasks using task-specific heads; and training on a joint task using a joint task head; deploying the fine-tuned network on a computing device; and using the deployed fine-tuned network to process inputs from two or more modalities and produce outputs.
Example 16. The system as recited in Example 15, wherein the encoder-decoder structure includes modality-specific organizers and shared components for cross-modality interactions.
Example 17. The system as recited in any one or more of Examples 15-16, wherein the shared backbone network comprises cross-attention blocks and transformer blocks.
Example 18. The system as recited in any one or more of Examples 15-17, wherein the mirrored decoder structure includes skip connections from the encoder.
Example 19. The system as recited in any one or more of Examples 15-18, wherein fine-tuning the pretrained unified transformer network further comprises: optimizing a fine-tuning objective that incorporates losses associated with individual tasks and joint tasks.
Example 20. A non-transitory machine-readable storage medium including instructions that, when executed by a machine, cause the machine to perform operations comprising: configuring a unified transformer network with an encoder-decoder structure for processing multiple modalities; pretraining the unified transformer network on paired modalities by: processing inputs from a first modality and a second modality through modality-specific networks and a shared backbone network; generating encoded representations for both modalities; and decoding the encoded representations using a mirrored decoder structure; fine-tuning the pretrained unified transformer network on multiple modalities and tasks to obtain a fine-tuned network, the fine-tuning comprising: training on individual modality tasks using task-specific heads; and training on a joint task using a joint task head; deploying the fine-tuned network on a computing device; and using the deployed fine-tuned network to process inputs from two or more modalities and produce outputs.

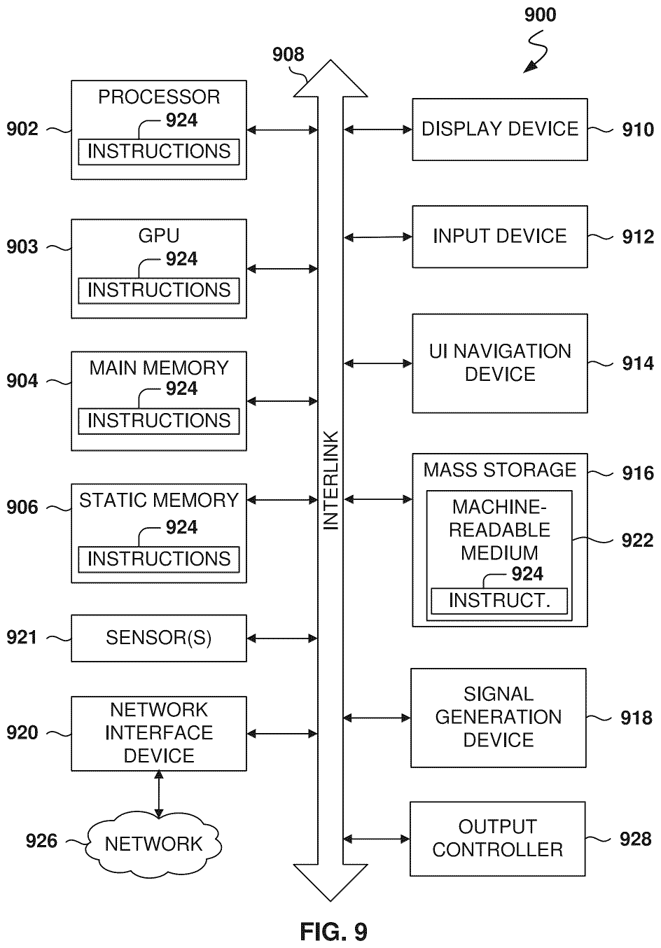

FIG. 9 is a block diagram illustrating an example of a machine 900 upon by which one or more examples described herein may be implemented or controlled. In alternative examples, the machine 900 may operate as a standalone device or be connected (e.g., networked) to other machines. In a networked deployment, the machine 900 may operate in the capacity of a server machine, a client machine, or both in server-client network environments. In an example, the machine 900 may act as a peer machine in a peer-to-peer (P2P) (or other distributed) network environment. Further, while only a single machine 900 is illustrated, the term “machine” shall also be taken to include any collection of machines that individually or jointly execute a set (or multiple sets) of instructions to perform any one or more of the methodologies discussed herein, such as via cloud computing, software as a service (Saas), or other computer cluster configurations.

Examples, as described herein, may include, or may operate by, logic, various components, or mechanisms. Circuitry is a collection of circuits implemented in tangible entities, including hardware (e.g., simple circuits, gates, logic). Circuitry membership may be flexible over time and underlying hardware variability. Circuitries include members that may, alone or in combination, perform specified operations when operating. In an example, the hardware of the circuitry may be immutably designed to carry out a specific operation (e.g., hardwired). In an example, the hardware of the circuitry may include variably connected physical components (e.g., execution units, transistors, simple circuits), including a computer-readable medium physically modified (e.g., magnetically, electrically, by moveable placement of invariant massed particles) to encode instructions of the specific operation. In connecting the physical components, the underlying electrical properties of a hardware constituent are changed (for example, from an insulator to a conductor or vice versa). The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other circuitry components when the device operates. In an example, any of the physical components may be used in more than one member of more than one circuitry. For example, under operation, execution units may be used in a first circuit of a first circuitry at one point in time and reused by a second circuit in the first circuitry or by a third circuit in a second circuitry at a different time.

The machine 900 (e.g., computer system) may include a hardware processor 902 (e.g., a central processing unit (CPU), a hardware processor core, or any combination thereof), a graphics processing unit (GPU 903), a main memory 904, and a static memory 906, some or all of which may communicate with each other via an interlink 908 (e.g., bus). The machine 900 may further include a display device 910, an alphanumeric input device 912 (e.g., a keyboard), and a user interface (UI) navigation device 914 (e.g., a mouse). In an example, the display device 910, alphanumeric input device 912, and UI navigation device 914 may be a touch screen display. The machine 900 may additionally include a mass storage device 916 (e.g., drive unit), a signal generation device 918 (e.g., a speaker), a network interface device 920, and one or more sensors 921, such as a Global Positioning System (GPS) sensor, compass, accelerometer, or another sensor. The machine 900 may include an output controller 928, such as a serial (e.g., universal serial bus (USB)), parallel, or other wired or wireless (e.g., infrared (IR), near field communication (NFC)) connection to communicate with or control one or more peripheral devices (e.g., a printer, card reader).

The processor 902 refers to any one or more circuits or virtual circuits (e.g., a physical circuit emulated by logic executing on an actual processor) that manipulates data values according to control signals (e.g., commands, opcodes, machine code, control words, macroinstructions, etc.) and which produces corresponding output signals that are applied to operate a machine. A processor 902 may, for example, include at least one of a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), a Tensor Processing Unit (TPU), a Neural Processing Unit (NPU), a Vision Processing Unit (VPU), a Machine Learning Accelerator, an Artificial Intelligence Accelerator, an Application Specific Integrated Circuit (ASIC), a Field Programmable Gate Array (FPGA), a Radio-Frequency Integrated Circuit (RFIC), a Neuromorphic Processor, a Quantum Processor, or any combination thereof.

The processor 902 may further be a multi-core processor having two or more independent processors (sometimes referred to as “cores”) that may execute instructions contemporaneously. Multi-core processors contain multiple computational cores on a single integrated circuit die, each of which can independently execute program instructions in parallel. Parallel processing on multi-core processors may be implemented via architectures like superscalar, VLIW, vector processing, or SIMD that allow each core to run separate instruction streams concurrently. The processor 902 may be emulated in software, running on a physical processor, as a virtual processor or virtual circuit. The virtual processor may behave like an independent processor but is implemented in software rather than hardware.

The mass storage device 916 may include a machine-readable medium 922 on which one or more sets of data structures or instructions 924 (e.g., software) embodying or utilized by any of the techniques or functions described herein. The instructions 924 may also reside, completely or at least partially, within the main memory 904, within the static memory 906, within the hardware processor 902, or the GPU 903 during execution thereof by the machine 900. For example, one or any combination of the hardware processor 902, the GPU 903, the main memory 904, the static memory 906, or the mass storage device 916 may constitute machine-readable media.

While the machine-readable medium 922 is illustrated as a single medium, the term “machine-readable medium” may include a single medium or multiple media (e.g., a centralized or distributed database and associated caches and servers) configured to store one or more instructions 924.

The term “machine-readable medium” may include any medium that is capable of storing, encoding, or carrying instructions 924 for execution by the machine 900 and that causes the machine 900 to perform any one or more of the techniques of the present disclosure or that is capable of storing, encoding, or carrying data structures used by or associated with such instructions 924. Non-limiting machine-readable medium examples may include solid-state memories and optical and magnetic media. For example, a massed machine-readable medium comprises a machine-readable medium 922 with a plurality of particles having invariant (e.g., rest) mass. Accordingly, massed machine-readable media are not transitory propagating signals. Specific examples of massed machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 924 may be transmitted or received over a communications network 926 using a transmission medium via the network interface device 920.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented separately. These and other variations, modifications, additions, and improvements fall within the scope of the subject matter herein.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

Additionally, as used in this disclosure, phrases of the form “at least one of an A, a B, or a C,” “at least one of A, B, and C,” and the like should be interpreted to select at least one from the group that comprises “A, B, and C.” Unless explicitly stated otherwise in connection with a particular instance, in this disclosure, this manner of phrasing does not mean “at least one of A, at least one of B, and at least one of C.” As used in this disclosure, the example “at least one of an A, a B, or a C” would cover any of the following selections: {A}, {B}, {C}, {A, B}, {A, C}, {B, C}, and {A, B, C}.

Moreover, plural instances may be provided for resources, operations, or structures described herein as a single instance. Additionally, boundaries between various resources, operations, modules, engines, and data stores are somewhat arbitrary, and particular operations are illustrated in the context of specific illustrative configurations. Other allocations of functionality are envisioned and may fall within the scope of various examples of the present disclosure. In general, structures and functionality are presented as separate resources in the example; configurations may be implemented as a combined structure or resource. Similarly, structures and functionality presented as a single resource may be implemented as separate resources. These and other variations, modifications, additions, and improvements fall within a scope of examples of the present disclosure as represented by the appended claims. Accordingly, the specification and drawings are to be regarded in an illustrative rather than a restrictive sense.

What is claimed is:

1. A method comprising:
configuring a unified transformer network with an encoder-decoder structure for processing multiple modalities;
pretraining the unified transformer network on paired modalities by:
processing inputs from a first modality and a second modality through modality-specific networks and a shared backbone network;
generating encoded representations for both modalities; and
decoding the encoded representations using a mirrored decoder structure;
fine-tuning the pretrained unified transformer network on multiple modalities and tasks to obtain a fine-tuned network, the fine-tuning comprising:
training on individual modality tasks using task-specific heads; and
training on a joint task using a joint task head;
deploying the fine-tuned network on a computing device; and
using the deployed fine-tuned network to process inputs from two or more modalities and produce outputs.

2. The method of claim 1, wherein the encoder-decoder structure includes modality-specific organizers and shared components for cross-modality interactions.

3. The method of claim 1, wherein a shared backbone network comprises cross-attention blocks and transformer blocks.

4. The method of claim 1, wherein the mirrored decoder structure includes skip connections from the encoder.

5. The method of claim 1, wherein the first modality and the second modality are selected from a group consisting of images, depth maps, 3D point clouds, videos, audio, and text.

6. The method of claim 1, wherein fine-tuning the pretrained unified transformer network further comprises:
optimizing a fine-tuning objective that incorporates losses associated with individual tasks and joint tasks.

7. The method of claim 1, further comprising:
tokenizing inputs from each modality before processing through the modality-specific networks.

8. The method of claim 7, wherein tokenizing inputs comprises:
for text modalities, segmenting text into word, subword, or character tokens;
for image modalities, dividing images into pixel or patch tokens;
for video modalities, extracting frame tokens or spatiotemporal tokens; and
for audio modalities, segmenting audio into time-domain or frequency-domain tokens.

9. The method of claim 1, wherein the unified transformer network is configured to share knowledge across multiple modalities to embed the modalities in a common embedding space.

10. The method of claim 1, wherein the individual modality tasks include at least one of object classification, object detection, text summarization, image recognition, scene recognition, and action recognition.

11. The method of claim 1, wherein the unified transformer network includes a three-stream architecture with unique and shared blocks to tokenize inputs from different modalities.

12. The method of claim 1, wherein the unified transformer network is configured to generate embeddings for input data points, wherein related data points from a same modality have smaller distances between their embeddings compared to embeddings from other modalities.

13. The method of claim 1, further comprising:
applying the unified transformer network to at least one of: autonomous vehicle technology, product image analysis, and generative artificial intelligence tasks.

14. The method of claim 1, wherein the unified transformer network is configured to leverage information from one modality to enhance performance in another modality.

15. A system comprising:
a memory comprising instructions; and
one or more computer processors, wherein the instructions, when executed by the one or more computer processors, cause the system to perform operations comprising:
configuring a unified transformer network with an encoder-decoder structure for processing multiple modalities;
pretraining the unified transformer network on paired modalities by:
processing inputs from a first modality and a second modality through modality-specific networks and a shared backbone network;
generating encoded representations for both modalities; and
decoding the encoded representations using a mirrored decoder structure;
fine-tuning the pretrained unified transformer network on multiple modalities and tasks to obtain a fine-tuned network, the fine-tuning comprising:
training on individual modality tasks using task-specific heads; and
training on a joint task using a joint task head;
deploying the fine-tuned network on a computing device; and
using the deployed fine-tuned network to process inputs from two or more modalities and produce outputs.

16. The system as recited in claim 15, wherein the encoder-decoder structure includes modality-specific organizers and shared components for cross-modality interactions.

17. The system as recited in claim 15, wherein the shared backbone network comprises cross-attention blocks and transformer blocks.

18. The system as recited in claim 15, wherein the mirrored decoder structure includes skip connections from the encoder.

19. The system as recited in claim 15, wherein fine-tuning the pretrained unified transformer network further comprises:
optimizing a fine-tuning objective that incorporates losses associated with individual tasks and joint tasks.

20. A non-transitory machine-readable storage medium including instructions that, when executed by a machine, cause the machine to perform operations comprising:
configuring a unified transformer network with an encoder-decoder structure for processing multiple modalities;
pretraining the unified transformer network on paired modalities by:
processing inputs from a first modality and a second modality through modality-specific networks and a shared backbone network;
generating encoded representations for both modalities; and
decoding the encoded representations using a mirrored decoder structure;
fine-tuning the pretrained unified transformer network on multiple modalities and tasks to obtain a fine-tuned network, the fine-tuning comprising:
training on individual modality tasks using task-specific heads; and
training on a joint task using a joint task head;
deploying the fine-tuned network on a computing device; and
using the deployed fine-tuned network to process inputs from two or more modalities and produce outputs.
